(19) United States
(12) Patent Application Publication
(10) Pub. No.: US 2006/0276207 A1
(43) Pub. Date: Dec. 7, 2006

(54) System and method for reducing short message service delay

(76) Inventors: John M. Harris, Chicago, IL (US); Ronald T. Crocker, St. Charles, IL (US); Thomas B. Hart, West Dundee, IL (US)

Correspondence Address: MOTOROLA, INC., 1303 EAST ALGONQUIN ROAD, IL01/3RD, SCHAUMBURG, IL, 60196, US

(21) Appl. No.: 11/146,334

(22) Filed: Jun. 6, 2005

(51) Int. Cl. H04Q 7/20

(52) U.S. Cl. 455/466

(57) ABSTRACT

A method of messaging in a wireless cellular system comprising predicting a location of the mobile station (122, 124), wherein the location corresponds to a first sector within the wireless cellular system; sending a first message to the mobile station via the first sector within the wireless cellular system; and sending a second message corresponding to and having a reduced size as compared to the first message to the mobile station via a second sector at approximately the same time as the first message is sent via the first sector.

### BACKGROUND OF THE INVENTION

1. Field of the Invention

The present invention relates to messaging. More specifically, the present invention relates to reducing the delay in the delivery of a short message service message.

2. Discussion of the Related Art

Traditionally, in wireless cellular communication systems in order to deliver a message to a mobile station, the message was sent directly over the paging channel in all areas within a paging zone on the first attempt to deliver the message. This was a large waste of the paging capacity. More recently in wireless cellular communication systems, in order to send a mobile station a Short Message Service (SMS) message, the location of the mobile station needs to be known for the cellular system to deliver the SMS message to the mobile station. The location of the mobile station is determined by sending a page to an entire metropolitan (or other large) area. The mobile station responds to the page to identify to the cellular system where the mobile station is located. Following, the mobile station is sent an SMS message from the cellular system. This system was modified as traffic on cellular systems started to increase. The cellular system was modified such that a page was only sent to a single zone within the metropolitan area. In order to permit the cellular system to locate a zone, i.e., a predefined plurality of adjacent cells, where the mobile station was most likely to be found, the mobile station performed a periodic autonomous registration process wherein the mobile station transmits a signal to the cellular system to indicate its identity and in what cell within a zone it is located. The cellular system would then page this zone before paging the entire metropolitan area. Both of these methods, however, greatly limited the capacity of the cellular system as more and more users started to use the cellular system. Additionally, these methods also incur a delay in the delivery of messages.

Even more recent systems have further reduced the number of cells in which a page is sent to identify the location of a mobile station. In more recent systems, the cellular system keeps track of the most recent time in which the mobile station's location was registered. If the elapsed time since the most recent registration is less than a predetermined threshold time, then the cellular system will only page the cell for which the mobile station was registered and its neighboring cells. This system identifies a cell or a sub-group of cells within a zone in order to reduce the initial paging resources in the cellular system for the initial page. Smart paging refers to the process of paging everywhere in the paging zone and then when the mobile responds delivering the packet immediately near where it responded. If the initial page does not locate the mobile station, a larger paging area can then be utilized. However, even in systems using this method or smart paging, the cellular system is often utilizing more resources or incurring more delay than necessary in order to identify the location of the mobile station in order to send a message (such as, for example, an short message service (SMS) message, a short data burst (SDB), a data burst message (DBM), or a data over signaling (DOS) message, to name but a few).

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a block diagram illustrating a cellular system in accordance with one embodiment;

FIG. 2 is a block diagram illustrating a cellular system in accordance with another embodiment; and

FIG. 3 is a flow diagram illustrating a method of messaging in a cellular system in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

One embodiment can be characterized as a method of messaging in a wireless cellular system comprising predicting a location of the mobile station, wherein the location corresponds to a first sector within the wireless cellular system; sending a first message to the mobile station via the first sector within the wireless cellular system; and sending a second message corresponding to and having a reduced size as compared to the first message to the mobile station via a second sector at approximately the same time as the first message is sent via the first sector.

Another embodiment can be characterized as a system for delivering a message to a mobile station comprising processing circuitry for predicting a location of the mobile station, wherein the location corresponds to a first sector within the wireless cellular system; and transmitting circuitry for sending a first message to the mobile station via the first sector within the wireless cellular system where the mobile station was last known to be located and for sending a second message having a reduced size as compared to the first message to the mobile station via a second sector at approximately the same time as the first message is sent via the first sector.

A subsequent embodiment can be characterized as a method of initiating a dedicated channel in a wireless cellular system comprising predicting a location of the mobile station, wherein the location corresponds to a first sector within the wireless cellular system; sending a channel assignment to the mobile station via the first sector within the wireless cellular system; and sending a page to the mobile station via a second sector at approximately the same time as the first data message is sent via the first sector.

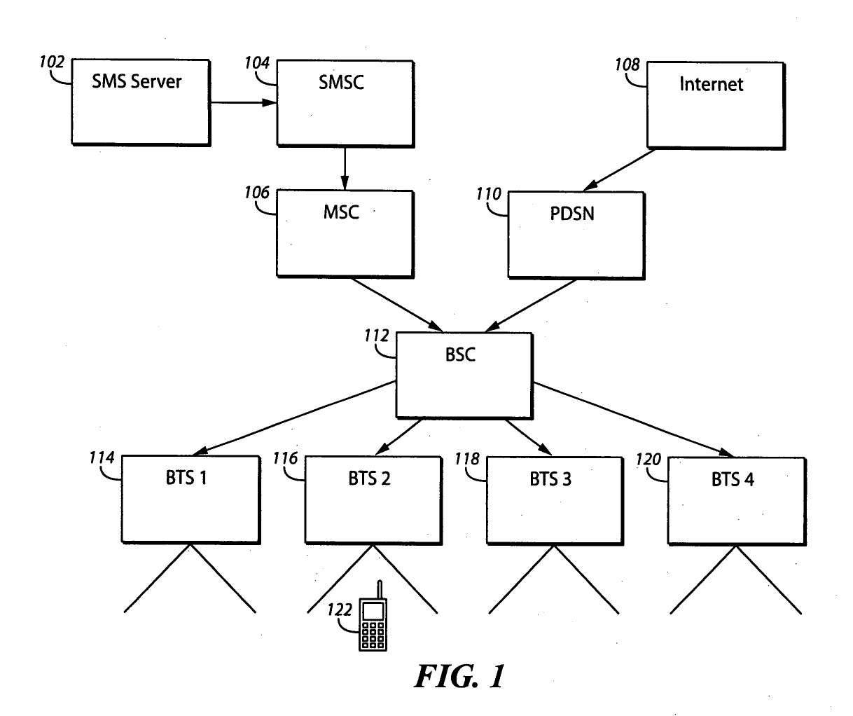

Referring to FIG. 1 a block diagram is shown illustrating a cellular system in accordance with one embodiment. Shown is a short message service (SMS) server 102, a short message service center (SMSC) 104, a mobile switching center (MSC) 106, the Internet 108, a packet data serving node (PDSN) 110, a base station controller (BSC) 112, a first base transceiver subsystem (BTS) 114, a second BTS 116, a third BTS 118, a fourth BTS 120, and a mobile station 122.

The SMS server 102 stores and forwards SMS messages for delivery to the mobile station 122 by sending a SMS message to the SMSC 104. The SMSC 104 forwards the SMS message to the MSC 106. The MSC 106 is connected to the BSC 112 and allows the BSC 112 to receive the SMS message. The mobile station 122 is shown as being in range of the second BTS 116. In accordance with the following examples, it will be assumed that the cellular system has predicted that the most likely location of the mobile station 122 is within a sector associated with the second BTS 116. In accordance with the present embodiment, when the BSC 112 receives the SMS message, the SMS message is forwarded to the BTS which covers a sector where the mobile station is most likely to be located. As shown, the mobile station is last known to be in a sector covered by the second BTS 116. At the same time, the BSC 112 directs the first BTS 114, the third BTS 118 and the fourth BTS 120 to send a message with a reduced size (e.g., a partial message or a page) to other sectors within the cellular system. Alternatively, each BTS can make the decision whether to send the entire SMS message or a reduced message depending upon the last known location of the mobile station. More generally, the cellular system determines a first sector for which a full message is sent and determines a second sector to which a message with a reduced size is also sent at approximately the same time. This determination is based upon the last known location of the mobile station or a prediction of the most likely sector within which the mobile station is located.

By sending the full message directly to the last known sector in which the mobile station 122 is most likely to be located, the time delay in delivering the full message is greatly reduced as compared to the prior systems discussed above in the background. For example, in many prior systems, the cellular system will receive a SMS message for delivery. The cellular system then sends a page out to a plurality of sectors. Upon receiving a response to the page from the mobile station 122, the cellular system will then deliver the SMS message to the mobile station 122. In contrast, as described above, in accordance with the present embodiment, when the cellular system receives a SMS message, the SMS message is sent directly to the mobile station 122 via a sector where the mobile station is last known to be located or most likely to be located (which may be the same sector). If the mobile station 122 is in the sector, the mobile station will receive the SMS message approximately five seconds sooner as compared to the prior systems. Additionally, the cellular system will send a page to the mobile station 122 via at least one additional sector at the same time as the SMS message is sent to the sector where the mobile station 122 is last known to be located or most likely to be located. If the mobile station 122 responds to the page, the cellular system will then send the full message to the mobile station 122 via the sector where the mobile station 122 is now known to be located because of the response to the page. Therefore, the present system reduces the time for delivery of an SMS message when the mobile station is in a last known sector and also pages at least one other sector so that the SMS message is still efficiently sent to the mobile station when the mobile station is not in the last known sector.

In accordance with the present embodiment, the full SMS message will be sent to a first sector in which the cellular system determines the mobile station is most likely located. Additionally, the cellular system sends a page to at least one additional sector. Usually, the cellular system will send the page to a plurality of additional sectors that are proximate the first sector. Thus, if the determination as to where the mobile station is located is incorrect, the mobile station will receive the page in most circumstances. Once the mobile station receives the page and acknowledges, the cellular system can forward the full SMS message.

In one embodiment, when the mobile station responds to the page that was sent via the additional sector, the response can include information about the mobile station's current environment. The information can include, for example, the received signal strength. The information can also include the mobile station address, other operating parameter modes and capabilities, and a response to an authentication challenge.

The cellular system utilizes the information from the mobile station 122 to determine whether to send the data from the SMS message over a paging channel or whether to assign a dedicated channel to the mobile station 122 over which the SMS message will be sent.

In another embodiment, a packet is received at the BSC 112 from, for example, the Internet 108 through the PDSN 110. As described herein the packet will be considered a full message. The packet is delivered to the second BTS 116 for delivery to the mobile station 122. The packet is directly sent to the mobile station via the last known sector in which the mobile station is located or to a sector where the mobile station is likely to be located. Additionally at the same time, a reduced message (e.g., a partial message or a page) is sent to the mobile station via at least one additional sector. As shown, the first BTS 114, the third BTS 118, and the fourth BTS 120 send a page to the mobile station 122 via three additional sectors. Similarly to the above example, if the mobile station 122 is in the last known sector, the mobile station 122 will receive the packet in a reduced time period as compared to prior systems. If the mobile station 122 is located in one of the additional sectors, the mobile station will receive the reduced message. Additionally, in one embodiment, the mobile station 122 will respond to the reduced message. Upon receiving the response the cellular system will send the full message (e.g., the packet) to the mobile station 122. It should be understood that while the cellular system sends a SMS message, a packet, a reduced message, or a page to the mobile station via a sector, this does not mean that the mobile station actually receives the message. If the mobile station 122 is not located in the sector, the mobile station 122 will not receive the message.

The previous two examples have been described in terms of a SMS system. However, the described embodiments also apply to other systems such as a short data burst (SDB) system, a Data over Signaling (DoS) system, a Data Burst Message (DBM) system, or a Multimedia Messaging System (MMS) system or systems placing user on a traffic channel, for example by an extended channel assignment message (ECAM). The methods described above also can apply to a group of mobile stations that a full message is to be delivered to. In this embodiment, the full message is sent to the sector where the largest number of mobile stations in the group is likely located.

In yet another embodiment, when the cellular system receives an incoming event that results in a traffic channel assignment to a mobile station, for example due to an incoming call or an incoming packet for a mobile station, the cellular system will send a channel assignment for the mobile station via a first sector where the mobile station is most likely located. Additionally, at the same time, the cellular system will page at least one additional sector. In this embodiment, if the mobile station receives the channel assignment via the first sector there will be a reduced delay in bringing up the traffic channel. In prior systems, in order to bring up a traffic channel, a page is sent to the mobile station via many sectors. After the mobile station responds to the page, the mobile station will then send the mobile station a channel assignment. Thus, the present embodiment also reduces the time to bring up a traffic channel in a cellular system as compared to prior systems. If the mobile station does not receive the channel assignment, however, the mobile station should receive the page in a different sector. Once the mobile station acknowledges the page, a channel can then be assigned by the cellular system or delivered over the paging channel. The present method can also be used to assign a channel for data transfer.

In order to determine the sector in which the mobile station is most likely located, the cellular system can use information from the mobile station's recent activity. To illustrate, the mobile station will use, for example, information such as a recent call ending, the mobile station sending a registration, the last know sector where the mobile station was located, or that the mobile station is known to be a stationary device in order to determine the sector where the mobile station is most likely located.

Other types of messages can also be sent from the cellular system to the mobile station 122 in accordance with other embodiments. As described, generally a full message is sent to the mobile station via a first sector and a reduced message is sent to the mobile station via a second sector at approximately the same time the full message is sent. For a push to talk (PTT) or so-called plain old telephony service (POTS) application, the full message is, in one embodiment, an invite to a session along with a session description protocol. The reduced message is only the invite or alternatively a page. Still alternatively, the full message (e.g., invite, session description protocol, and a channel assignment) is sent via a first sector where the mobile station is most likely located. A reduced message (e.g., the invite plus session descriptor protocol) is sent via a second sector and a further reduced message (e.g., a page) is sent via a third sector.

For a voice mail notification the full message includes, for example, a number of voice mails and for each voice mail the message will preferably include a caller identification, a length of the message, a time the message was left, and a location of the caller at the time the message was left. The reduced message then includes, for example, the number of voice mails and the caller identification for each message. A further reduced message includes, for example, the number of voice mails. And a still further reduced message includes, for example, a notification that there are voice mails. An even further reduced message is a page, in accordance with one embodiment.

To illustrate, for a message such as a stock alert notification the full message includes, for example, a current price for each stock being tracked. A reduced message includes, for example, a current price only for stocks that have changed more than a threshold amount in value. A further reduced message includes, for example, a basic message indicating that some stock threshold or trigger has been activated. This basic message may trigger a user of the mobile station to contact a brokerage by phone or the Internet to determine what may have caused the trigger. An even further reduced message is a page, in accordance with one embodiment. Other examples of a full message and a reduced method are also can be contemplated for other applications and are within the scope of the described embodiments.

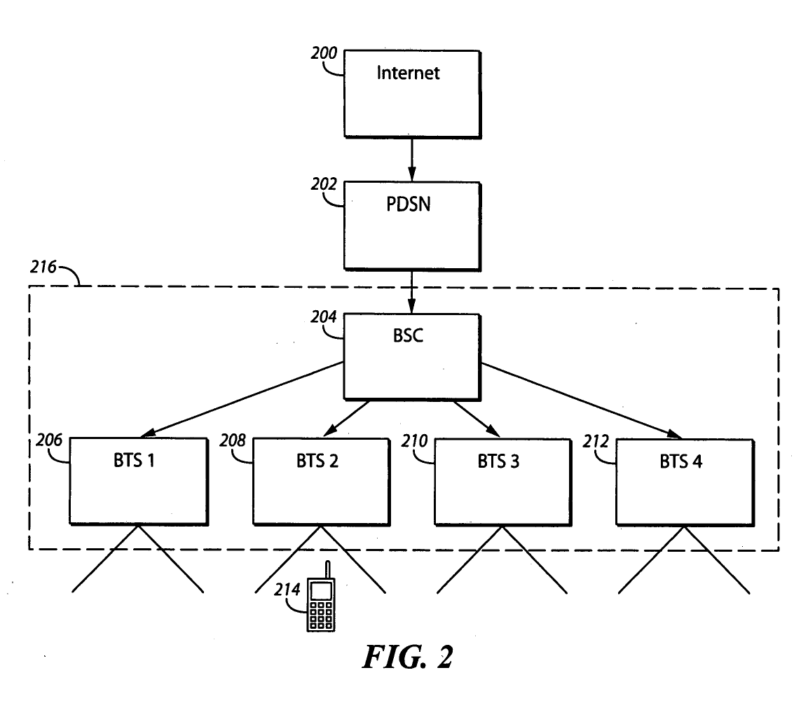

Referring to FIG. 2 a block diagram is shown illustrating a cellular system in accordance with another embodiment. Shown is the Internet 200, a PDSN 202, a BSC 204, a first BTS 206, a second BTS 208, a third BTS 210, a fourth BTS 212, a mobile station 214, and a base subsystem 216. The cellular system shown is a CDMA 1x EV-DO system that is used to send high rate packet data.

The base subsystem 216 includes the BSC 204, the first BTS 206, the second BTS 208, the third BTS 210, and the fourth BTS 212. The Internet 200 is connected to the BSC 204 through the PDSN 202. The BSC 204 is connected to the first BTS 206, the second BTS 208, the third BTS 210, and the fourth BTS 212.

In operation, a data packet is sent from the Internet 200 to the BSC 204 through the PDSN 202. In one embodiment, the BSC 204 forwards the data packet to the second BTS 208 and the second BTS 208 sends the data packet to the mobile station 214 via a first sector. Additionally, the BSC 204 sends a message to at least one of the first BTS 206, the third BTS 210 and the fourth BTS 212 to send a page to the mobile station 214 via one or more additional sectors. Alternatively, the BSC 204 will forward the packet data to the first BTS 206, the second BTS 208, the third BTS 210, and the fourth BTS 212. Each BTS will determine whether a sector they are associated with is a sector the mobile station 214 is most likely to be located in and based upon the determination will send the data packet to the mobile station 214 or send a page to the mobile station 214. If the mobile station is located in the first sector, the mobile station will receive the packet in a reduced time as compared to prior system. If the mobile station is located in one of the sectors to which the page was sent, once the mobile station responds to the page, the packet can then be delivered in that sector.

As described above with reference to FIGS. 1 and 2, each BTS has been described as covering a single sector. It should be understood, however, that a BTS can cover multiple sectors. Thus, as a specific example, the second BTS could send a full message to the mobile station via a first sector and the second BTS could also send a reduced message to the mobile station via a second sector.

Additionally, the embodiments described above with reference to FIGS. 1 and 2 have been described in specific implementations. More generally, a cellular system includes processing circuitry for utilizing a recent event of a mobile station to predict a location of the mobile station, wherein the location corresponds to a first sector within the wireless cellular system. The processing circuitry is implemented in various different parts of the cellular system infrastructure in different embodiments. Additionally, the cellular system includes transmitting circuitry for sending a data message to the mobile station via the first sector within the wireless cellular system where the mobile station was last known to be located and for sending a second data message having a reduced size as compared to the first data message to the mobile station via a second sector at approximately the same time as the data message is sent to the first sector. Again, the transmitting circuitry is implemented in various different parts of the cellular system infrastructure in different embodiments.

As used herein, those skilled in the art will appreciate that “circuitry” can refer to a dedicated fixed-purpose circuit or circuits and/or partially or wholly programmable platforms of various types and that these teachings are compatible with any such mode of deployment described herein. Additionally, circuit refers to any type of executable instructions that can be implements as, for example, hardware, firmware, and or software, which are all within the scope of the various teachings described.

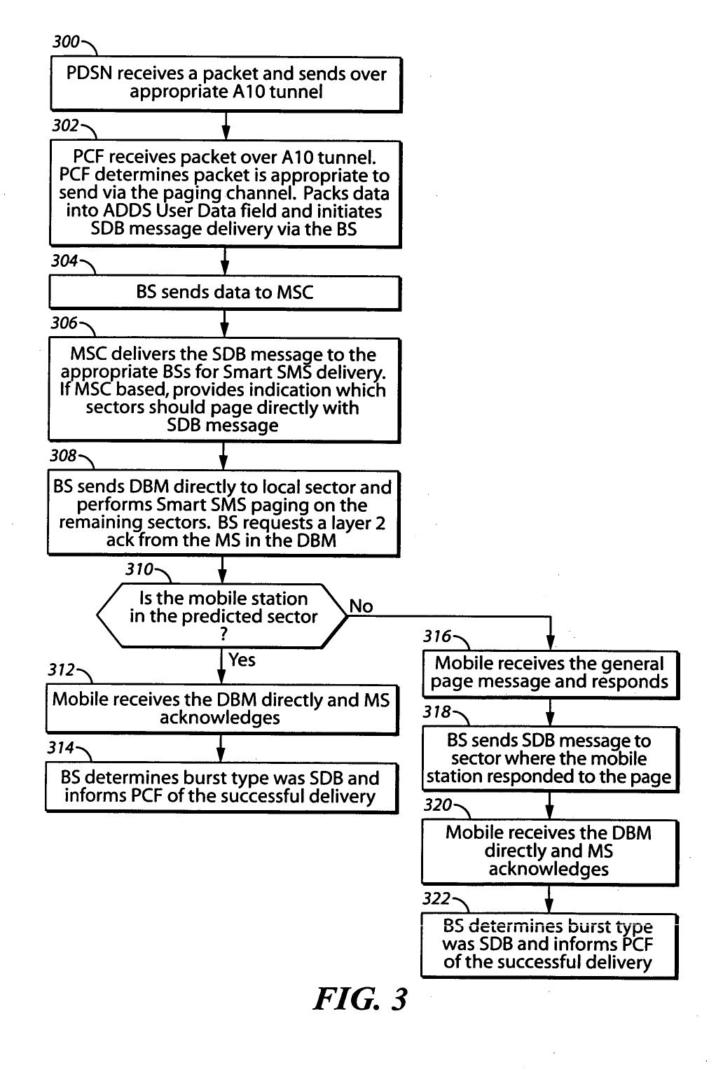

Referring to FIG. 3 a flow diagram is shown illustrating a method of messaging in a cellular system in accordance with an embodiment of the present invention.

In step 300, a packet data serving node (PDSN) receives packet data intended for a mobile station and sends the packet data to a packet control function (PCF) over an appropriate Al 0 line. Next in step 302, the PCF receives the packet data and determines if the packet data is appropriate to send via a paging channel. The PCF then initiates a short data burst (SDB) message delivery to the mobile station via a base station, preferably by including the packet data in an Application Data Delivery Service (ADDS) User Part of an A9-Short Data Delivery message, which ADDS User Part is formed in an SDB message format, and conveying the A9-Short Data Delivery message to the base station. In response to receiving the packet data, the base station acknowledges receipt of the packet data, preferably by conveying an A9-Short Data Ack to the PCF. At step 304, the base station conveys the received packet data to a mobile switching center (MSC), preferably by including the packet data, in an SDB message format, in an ADDS User Part of an BS Service Request message and conveying the BS Service Request message to the MSC. In response, the MSC may acknowledge that the MSC can support delivery of the data.

Next in step 306, the MSC delivers the received packet data to one or more appropriate base stations for smart SMS delivery, preferably by including the data, in an SDB message format, in an ADDS User Part of an ADDS Page message and conveying the an ADDS Page message to one or more appropriate base stations. If the MSC keeps track of predicting the location of the mobile station, the MSC can also provide an indication of which sector the packet data should be sent.

Next, in step 308, a base station of the one or more base stations sends the SDB message comprising the packet data directly to the sector indicated by the MSC. Preferably the base station includes the SDB message in a Data Burst Message (DBM) and conveys the DBM to the indicated sector, and via the sector, to the mobile station. The base station further informs that the included data is an SDB message by appropriately setting a Burst Type field of the DBM. Further, the one or more base stations page at least one additional sector or use smart paging. When the base station of the one or more base stations keeps track of the location information for the mobile station, the base station will make the determination as to which sector to send the SDB message directly and may further determine which sector(s) to page. The base station also requests a layer 2 acknowledgment from the mobile station in the SDB message. In step 310, if the mobile station is in the predicted sector, then the process continues with step 312. When the mobile station is in the additional sector(s) that a page is sent to, then the process continues with step 316.

In step 312, the mobile station receives the SDB message directly and acknowledges receipt to the base station. Following, the base station determines the burst type was a short data burst and informs the PCF of the successful delivery in step 314.

In step 316, the mobile station receives the general page and acknowledges receipt of the general page to the base station sourcing the general page. Following, in step 318, the base station sourcing the general page then sends the SDB message to the mobile station, preferably by including the SDB message in a DBM that is conveyed to the mobile station, via the sector that the mobile station employed when responding to the general page. The base station may further inform that the included data is an SDB by appropriately setting a Burst Type field of the DBM.

In step 320, the mobile station receives the SDB message directly and acknowledges receipt to the base station. Following, the base station determines the burst type was a short data burst and informs the PCF of the successful delivery, in step 322.

The embodiments described herein can be utilized with many different cellular systems, for example, CDMA systems such as CDMA2000, HRPD/DO, HRPDA/DOA, attitude 802.16, and EVDV. While FIG. 3 has been described with reference to delivery of an SDB message to the mobile station, the described embodiment may also apply to other systems such as a short message service (SMS) system, a Data over Signaling (DoS) system, a Data Burst Message (DBM) system, or a Multimedia Messaging System (MMS) system or systems placing users on a traffic channel, for example by an extended channel assignment message (ECAM).

As described herein a mobile station is any electronic device that can communicate through a cellular system, such as for example, a cellular telephone, a two way pager, a personal digital assistant (PDA), or other similar devices.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We Claim:

1. A method of messaging in a wireless cellular system comprising:
predicting a location of a mobile station, wherein the location corresponds to a first sector within the wireless cellular system;
sending a first message to the mobile station via the first sector within the wireless cellular system; and
sending a second message corresponding to and having a reduced size as compared to the first message to the mobile station via a second sector at approximately the same time as the first message is sent via the first sector.

2. A method of messaging in a wireless cellular system of claim 1, wherein the step of predicting the location of the mobile station utilizes at least one of a known location of the mobile station and a recent event of the mobile station.

3. A method of messaging in a wireless cellular system of claim 1 further comprising:
receiving a response from the mobile station in response to the mobile station receiving the second message; and
sending the first message to the mobile station via the second sector.

4. A method of messaging in a wireless cellular system of claim 3 wherein the first message is a first data message;
wherein the second message is a page to the mobile station sent over a common channel;
wherein the response to the page includes data corresponding to the mobile stations current environment; and
wherein the method further comprises determining whether to send the first data message to the mobile station over the common channel or a dedicated channel based upon the response to the page.

5. A method of messaging in a wireless cellular system of claim 1 wherein the first message is one of a short message service message, a data over signaling message, a data burst message, and a short data burst message and the second message is a page.

6. A method of messaging in a wireless cellular system of claim 1 wherein the first message is a channel assignment and the second data message is a page.

7. A method of messaging in a wireless cellular system of claim 6 further comprising:
receiving a response from the mobile station in response to the mobile station receiving the page; and
sending a second channel assignment to the mobile station via the second sector.

8. A method of messaging in a wireless cellular system of claim 7 further comprising receiving a request to bring up a call.

9. A method of messaging in a wireless cellular system of claim 1 wherein the first message includes message data and a channel assignment and the second message includes one of the message data and a page.

10. A method of messaging in a wireless cellular system of claim 1 further comprising sending a third message corresponding to and having a reduced size as compared to the second message to the mobile station via a third sector at approximately the same time as the second message is sent via the second sector.

11. A system for delivering a message to a mobile station comprising:
processing circuitry for predicting a location of the mobile station, wherein the location corresponds to a first sector within the wireless cellular system; and
transmitting circuitry for sending a first message to the mobile station via the first sector within the wireless cellular system where the mobile station was last known to be located and for sending a second message having a reduced size as compared to the first message to the mobile station via a second sector at approximately the same time as the first message is sent via the first sector.

12. A system for delivering a message to a mobile station of claim 11, wherein the predicting the location of the mobile station utilizes at least one of a known location of the mobile station and a recent event of the mobile station.

13. A system for delivering a message to a mobile station of claim 1 further comprising:
receiving circuitry for receiving a response from the mobile station in response to the mobile station receiving the second message;
wherein the transmitting circuitry further sends the first message to the mobile station via the second sector.

14. A system for delivering a message to a mobile station of claim 13 wherein the first message is a first data message;
wherein the second message is a page to the mobile station sent over a common channel;
wherein the response to the page from the mobile station includes data corresponding to the mobile stations current environment; and
wherein a determination is made whether to send the first data message to the mobile station over the common channel or a dedicated channel based upon the response to the page.

15. A system for delivering a message to a mobile station of claim 11 wherein the first message is one of a short message service message, a data over signaling message, a data burst message, and a short data burst message and the second message is a page.

16. A system for delivering a message to a mobile station of claim 11 wherein the first message is a channel assignment and the second message is a page.

17. A system for delivering a message to a mobile station of claim 16 further comprising:
receiving circuitry for receiving a response from the mobile station in response to the mobile station receiving the page; and
wherein the transmitting circuitry further sends a second channel assignment to the mobile station via the second sector.

18. A system for delivering a message to a mobile station of claim 17 wherein the receiving circuitry further receives a request to bring up a call.

19. A system for delivering a message to a mobile station of claim 11 wherein the first message includes message data and a channel assignment and the second message includes one of the message data and a page.

20. A system for delivering a message to a mobile station of claim 11 further comprising sending a third message corresponding to and having a reduced size as compared to the second message to the mobile station via a third sector at approximately the same time as the second message is sent via the second sector.
